(19) United States
(12) Patent Application Publication
(10) Pub. No.: US 2007/0218263 A1
(43) Pub. Date: Sep. 20, 2007

(54) Thermal laminating film and method of manufacture

(75) Inventors: Yu-Bo Huang, Lombard, IL (US); Samuel P. Amdahl, Prospect Heights, IL (US)

Correspondence Address: MICHAEL BEST & FRIEDRICH, LLP, 100 EAST WISCONSIN AVENUE, SUITE 3300, MILWAUKEE, WI, 53202, US

(73) Assignee: General Binding Corporation, Northbrook, IL (US)

(21) Appl. No.: 11/378,865

(22) Filed: Mar. 17, 2006

(51) Int. Cl. B32B 27/30; B32B 27/32; B32B 27/22

(52) U.S. Cl. 428/215; 428/339; 428/411.1; 428/522; 428/523

(57) ABSTRACT

An improved thermal laminating film includes a tackified resin. The film can be manufactured by extruding the tackified resin onto a base layer of the film.

### FIELD OF THE INVENTION

The present invention relates to thermal laminating films, and more particularly to thermal laminating films for laminating media.

### BACKGROUND OF THE INVENTION

Thermal laminating films are typically used to protect printed media from being torn or scratched, and are also used to prevent smearing, smudging, or fading of the ink on the printed media. Conventional thermal laminating films typically include a base layer or substrate of thermoplastic polymer material and a resin layer that is bonded to the base layer. A typical resin layer consists of one or more high molecular weight mostly pure polymeric resins, such as an ethylene vinyl acetate copolymer resin.

### SUMMARY OF THE INVENTION

Depending on the ink used on the printed media, and the material of the media itself, successfully laminating the printed media can be difficult. Particularly, glycol-formulated inks can reduce the adhesion of the polymeric resin layer of the laminating film to a printed media, therefore increasing the likelihood that the film will delaminate from the printed media.

The present invention provides, in one aspect, a thermal laminating film including a tackified resin that will reduce the likelihood that the film will delaminate from the printed media.

The present invention provides, in another aspect, a thermal laminating film including a base layer, a polymeric resin layer coupled to the base layer, and a tackified resin layer coupled to the polymeric resin layer.

The present invention provides, in yet another aspect, a method of manufacturing a thermal laminating film. The method includes providing a base layer and extruding a tackified resin layer into coupled relation with the base layer.

Other features and aspects of the invention will become apparent by consideration of the following detailed description and accompanying drawings.

### BRIEF DESCRIPTION OF THE DRAWINGS

FIG. 1 is a cross-sectional view of a first construction of a thermal laminating film of the present invention.

FIG. 2 is a cross-sectional view of a second construction of the thermal laminating film of the present invention.

FIG. 3 is a schematic view illustrating a manufacturing process for making the thermal laminating film of FIG. 1.

FIG. 4 is a schematic view illustrating a manufacturing process for making the thermal laminating film of FIG. 2.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

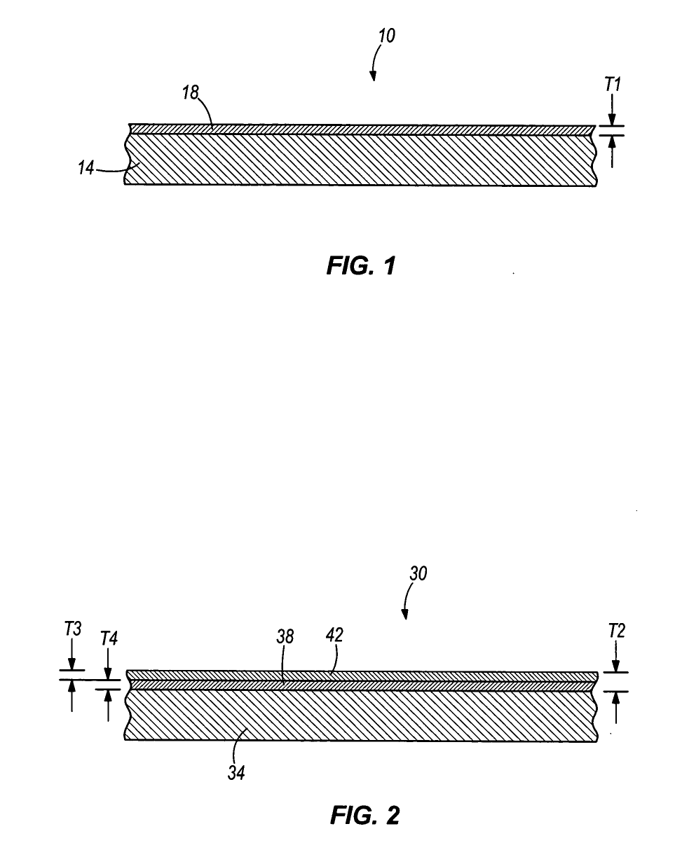

FIG. 1 illustrates a 2-layer thermal laminating film 10 embodying the present invention. This and other laminating films described herein are of the clear type used for laminating printed media (e.g., posterboards, pictures, signs, etc.). These laminating films are distinct from other films commonly used in packaging and other fields. The laminating film 10 includes a substrate or base layer 14 and a “tackified resin” layer 18 configured to couple or bond the base layer 14 to a piece of printed media. As used herein and in the appended claims, a tackified resin includes a composition of one or more polymeric resins and one or more low-molecular-weight hydrocarbon resins (about 200 to about 12,000 grams/mol) or “tackifier resins.” The low-molecular-weight hydrocarbon resins are tackifiers that increase the adhesion or bonding strength of the polymeric resin, and thus the thermal laminating film 10, to the printed media.

The base layer 14 may comprise any suitable thermoplastic polymer sheet material useful for thermal lamination applications. Preferably, the base layer 14 is translucent or transparent, and possesses surface characteristics and other physical properties such as flexibility, durability, hardness, scratch resistance and the like for protecting printed media to which the thermal laminating film 10 may be applied. Illustrative thermoplastic polymer sheet materials that may be used for the base layer 14 include oriented polypropylene, polyesters, polyamides (e.g., Nylon), polyvinyl chloride, acetates and polycarbonates.

With continued reference to FIG. 1, the polymeric resins that may be used in the tackified resin layer 18 include, but are not limited to: ethylene vinyl acetate copolymer (“EVA”), low density polyethylene, ethylene methyl acrylate, ethylene methyl methacrylate and ethylene ethyl acrylate as well as any other derivative of ethylene acrylate copolymers. Such polymeric resins are otherwise known as long chain polymers having a melt index below about 500 grams/10 min. at 190° C. according to ASTM D1238. In situations where more than one polymeric resin is used in the tackified resin layer 18, at least one of the polymeric resins should have a melt index below about 500 grams/10 min. at 190° C. With respect to ethylene copolymers used, the vinyl acetate or acrylate content may be about 5% to about 40%. With respect to low-density polyethylene polymers used, the density of the polyethylene polymers may be about 0.86 kg/L to about 0.92 kg/L.

In one construction of the thermal laminating film 10, the tackified resin layer 18 includes about 30% to about 80% by weight of one or more of the polymeric resins. In another construction, the tackified resin layer 18 includes about 50% to about 70% by weight of one or more of the polymeric resins. In yet another construction, the tackified resin layer 18 includes about 60% to about 80% by weight of one or more of the polymeric resins. In yet another construction, the tackified resin layer 18 includes about 40% to about 60% by weight of one or more of the polymeric resins. It is understood that any numerical range recited herein includes all values from the lower value to the upper value. For example, if a concentration range is stated as about 1% to about 50%, it is intended that values such as 2% to 40%, 10% to 30%, or 1% to 3%, etc., are expressly enumerated in this specification. These are only examples of what is specifically intended, and all possible combinations of numerical values between the lowest value and the highest value enumerated are to be considered to be expressly stated in this application.

In one construction of the thermal laminating film 10, the tackified resin layer 18 includes at least about 30% by weight of one or more of the polymeric resins. In other constructions, the tackified resin layer 18 includes at least about 35% by weight, at least about 40% by weight, at least about 45% by weight, at least about 50% by weight, at least about 55% by weight, at least about 60% by weight, at least about 65% by weight, at least about 70% by weight, at least about 75% by weight with a maximum of about 80% by weight.

In another construction of the thermal laminating film 10, the tackified resin layer 18 includes less than or equal to about 80% by weight of one or more of the polymeric resins. In yet other constructions, the tackified resin layer 18 includes less than about 75% by weight, less than about 70% by weight, less than about 65% by weight, less than about 60% by weight, less than about 55% by weight, less than about 50% by weight, less than about 45% by weight, less than about 40% by weight, less than about 35% by weight with a minimum of about 30% by weight.

The low-molecular-weight hydrocarbon resins (LMW hydrocarbon resin(s)) or tackifier resins that may be used in the tackified resin layer 18 include, but are not limited to: aliphatic hydrocarbons, aromatic hydrocarbons, cycloaliphatic hydrocarbons, rosin, and rosin esters. In order to be light in color (to ultimately provide a clear laminating film) and thermally stable, such LMW hydrocarbon resins may be fully or partially hydrogenated. The molecular weight of the LMW hydrocarbon resins may be about 200 to about 12,000 grams/mol. In one construction, the molecular weight of the LMW hydrocarbon resins may be about 200 to about 10,000 grams/mol. In another construction, the molecular weight of the LMW hydrocarbon resins may be about 200 to about 8,000 grams/mol. In yet another construction, the molecular weight of the LMW hydrocarbon resins may be about 200 to about 6,000 grams/mol. In another construction, the molecular weight of the LMW hydrocarbon resins may be about 200 to about 4,000 grams/mol. In another construction, the molecular weight of the LMW hydrocarbon resins may be about 200 to about 2,500 grams/mol.

In one construction of the thermal laminating film 10, the tackified resin layer 18 includes about 20% to about 70% by weight of one or more of the LMW hydrocarbon resins. In another construction, the tackified resin layer 18 includes about 30% to about 50% by weight of one or more of the LMW hydrocarbon resins. In yet another construction, the tackified resin layer 18 includes about 20% to about 45% by weight of one or more of the LMW hydrocarbon resins. In yet another construction, the tackified resin layer 18 includes about 40% to about 65% by weight of one or more of the LMW hydrocarbon resins.

In one construction of the thermal laminating film 10, the tackified resin layer 18 includes at least about 20% by weight of one or more of the hydrocarbon or tackifier resins. In other constructions, the tackified resin layer 18 includes at least about 25% by weight, at least about 30% by weight, at least about 35% by weight, at least about 40% by weight, at least about 45% by weight, at least about 50% by weight, at least about 55% by weight, at least about 60% by weight, at least about 65% by weight with a maximum of about 70% by weight of one or more of the LMW hydrocarbon or tackifier resins.

In another construction of the thermal laminating film 10, the tackified resin layer 18 includes less than or equal to about 70% by weight of one or more of the hydrocarbon or tackifier resins. In yet other constructions, the tackified resin layer 18 includes less than about 65% by weight, less than about 60% by weight, less than about 55% by weight, less than about 50% by weight, less than about 45% by weight, less than about 40% by weight, less than about 35% by weight, less than about 30% by weight, less than about 25% by weight with a minimum of about 20% by weight of one or more of the LMW hydrocarbon or tackifier resins.

In yet another construction of the thermal laminating film 10, one or more additives may be included in the tackified resin layer 18 to improve properties other than the lamination bonding strength. Such additives may include antioxidation additives, UV absorbers, anti-blocking agents, anti-slip agents, and polyethylene or EVA waxes for viscosity adjustment or improved compatibility among the components in the tackified resin layer 18. Quantities for these additives in the tackified resin layer 18, if utilized, may be less than about 5% by weight.

With continued reference to FIG. 1, in one construction of the 2-layer thermal laminating film 10, the tackified resin layer 18 includes a thickness T1 of at least about 4 microns. In other constructions of the thermal laminating film 10, the thickness T1 of the tackified resin layer 18 may be at least about 13 microns, at least about 25 microns, at least about 50 microns, at least about 100 microns, and at least about 150 microns with a maximum of about 200 microns.

In another construction of the 2-layer thermal laminating film 10, the thickness T1 of the tackified resin layer 18 may be less than about 200 microns. In yet other constructions of the thermal laminating film 10, the thickness T1 of the tackified resin layer 18 may be less than about 150 microns, less than about 100 microns, less than about 50 microns, less than about 25 microns, and less than about 13 microns with a minimum of about 4 microns.

FIG. 2 illustrates a 3-layer thermal laminating film 30 embodying the present invention and including the substrate or base layer 34, a polymeric resin layer or “tie” layer 38, and a tackified resin layer 42 configured to couple or bond the base layer 34 and the tie layer 38 to a piece of printed media. The base layer 34 and the tackified resin layer 42 may be made from any of the materials described above with reference to the 2-layer thermal laminating film 10, and the base layer 34 and the tackified resin layer 42 may have substantially the same compositions as described above with reference to the 2-layer thermal laminating film 10.

Depending upon the component materials in the base layer 34 and the component materials in the tackified resin layer 42, utilizing the tie layer 38 between the base layer 34 and the tackified resin layer 42 may improve the adhesion or bonding of the tackified resin layer 42 to the base layer 34. For example, constructing the 2-layer thermal laminating film utilizing a tackified resin layer with a relatively low melt viscosity (i.e., a melt index greater than 65 grams/10 min. at 190° C.) may yield decreased adhesion between the base layer and the tackified resin layer. However, when utilizing such a tackified resin layer with a relatively low melt viscosity, a tie layer comprising a material having a higher melt viscosity can be utilized to facilitate adhesion and bonding between the base layer and the tackified resin layer. Furthermore, some embodiments of the 3-layer film 30 can use less of the tackifier resins than the 2-layer film 10. Because the tackifier resins are typically more expensive than the polymeric resins used in the tie layer 38, this can provide a cost advantage to manufacturing and using the 3-layer film 30 over the 2-layer film 10.

Like the polymeric resins in the tackified resin layer 42, the polymeric resins that may be used in the tie layer 38 include without limitation: EVA, low density polyethylene, ethylene methyl acrylate, ethylene methyl methacrylate and ethylene ethyl acrylate as well as any other derivative of ethylene acrylate copolymers. Such polymeric resins may have a melt index of about 3 to about 800 grams/10 min. at 190° C. With respect to ethylene copolymers used in the polymeric resin, the vinyl acetate or acrylate content may be about 5% to about 40%. With respect to low-density polyethylene polymers used in the polymeric resin, the density of the polyethylene polymers may be about 0.86 kg/L to about 0.92 kg/L. It may be beneficial to use the same or similar polymeric resins in the tie layer 38 as are used in the tackified resin layer 42 to facilitate bonding between the tie layer 38 and the tackified resin layer 42.

With continued reference to FIG. 2, in one construction of the 3-layer thermal laminating film 30, the tackified resin layer 42 and the tie layer 38 include a combined thickness T2 of at least about 4 microns. In other constructions of the thermal laminating film 30, the thickness T2 of the tackified resin layer 42 and the tie layer 38 may be at least about 13 microns, at least about 15 microns, at least about 35 microns, at least about 50 microns, at least about 100 microns, and at least about 150 microns with a maximum of about 200 microns.

In another construction of the 3-layer thermal laminating film 30, the thickness T2 of the tackified resin layer 42 and the tie layer 38 may be less than about 200 microns. In yet other constructions of the thermal laminating film 30, the thickness T2 of the tackified resin layer 42 and the tie layer 38 may be less than about 150 microns, less than about 100 microns, less than about 50 microns, less than about 35 microns, less than about 15 microns, and less than about 13 microns with a minimum of about 4 microns.

Further, in one construction of the 3-layer thermal laminating film 30, the tackified resin layer 42 and the tie layer 38 may include individual thicknesses T3 and T4, respectively, of at least 2 microns. In other constructions of the thermal laminating film 30, the individual thickness T3 of the tackified resin layer 42 may be at least about 3 microns, at least about 5 microns, at least about 25 microns, at least about 50 microns, at least about 100 microns, and at least about 150 microns with a maximum of about 198 microns. Likewise, in yet other constructions of the thermal laminating film 30, the individual thickness T4 of the tie layer 38 may be at least about 10 microns, at least about 25 microns, at least about 30 microns, at least about 50 microns, at least about 100 microns, and at least about 150 microns with a maximum of about 198 microns.

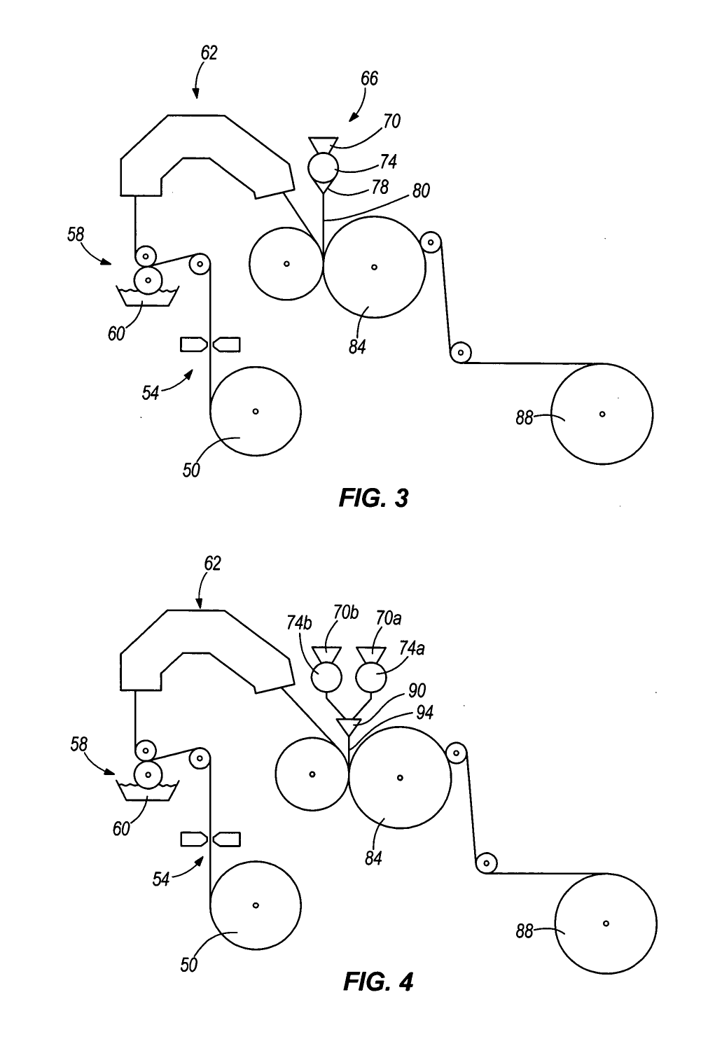

FIG. 3 illustrates a process for manufacturing the 2-layer thermal laminating film 10. A roll of thermoplastic polymer sheet material 50 comprising the substrate or base layer 14 is provided. The roll 50 is unwound such that the base layer 14 first passes through a corona treatment station 54, in which the surface of the base layer 14 to be coupled to the tackified resin layer 18 is corona treated in a corona-treating device such as that which is commercially available from Corona Design of Garland, Tex., at a setting of at least about 45 dynes. The corona treatment increases the surface energy of the base layer 14 to improve wettability of the base layer 14 and therefore the adhesion of the tackified resin layer 18 and the optional primer coating discussed below. Alternatively, other methods and processes may be used to treat the surface of the base layer 14 to be coupled to the tackified resin layer 18, including, for example, flame treating and UV-treating the base layer 14. However, the corona treatment, flame treatment, or UV treatment discussed above, as well as other similar surface treatments, are only optional and may be eliminated.

The corona-treated base layer 14 then passes through an optional primer coating station 58, in which a thin coat of primer 60 (e.g., a polyethylene imine solution of less than 1% solid) is applied onto the corona-treated surface of the base layer 14. After passing through the primer coating station 58, the primer coating on the base layer 14 is dried in a drying station 62 at a temperature of about 150° F. to about 200° F. With some formulations of the 2-layer thermal laminating film 10, the application of the primer coating may be eliminated.

The primed, corona-treated base layer 14 is then fed through an extrusion coating device 66 to apply the tackified resin layer 18 into coupled relation with the treated surface of the base layer 14 to form the thermal laminating film 10. Generally, as used herein and in the appended claims, the terms “extrude”, “extrusion”, and various forms thereof may be defined as a process of melting or liquefying a resin and forcing the liquefied resin through a die. Specifically, the extrusion coating device 66 includes a hopper 70 in which formulated pellets of raw component materials of the tackified resin layer 18 are stored. The pellets of tackified resin can be formulated to a relatively high melt viscosity (i.e., a melt index less than 65 grams/10 min. at 190° C.). As discussed above, other additives, such as antioxidation additives, UV absorbers, anti-blocking agents, anti-slip agents, and polyethylene or EVA waxes may be formulated with the pellets that ultimately form the tackified resin layer 18.

The extrusion coating device 66 also includes an extruder 74 that receives the pellets of raw material from the hopper 70, heats the pellets to liquefy the raw material, and discharges or extrudes the liquefied raw material through a die 78 to create a curtain or flow 80 of the tackified resin layer 18 for direct application to the base layer 14. Such an extrusion process may be referred to as a single extrusion process because only a single extruder 74 is utilized to melt and directly extrude the tackified resin layer 18 onto the base layer 14. Extrusion coating may be performed using commercially available extrusion coating equipment available from Black Clawson Converting Machinery of Fulton, N.Y. and RandCastle Extrusion Systems Incorporated in Cedar Grove, N.J.

The tackified resin layer 18 is directly extruded onto the base layer 14 at a temperature of about 150° C. to about 250° C. to form the thermal laminating film 10. With continued reference to FIG. 3, the film is then cooled by a chilled roller 84, which is known in the art. After cooling, the finished thermal laminating film 10 is wound into a roll 88 for subsequent manufacturing processes or transport.

FIG. 4 illustrates a process for manufacturing the 3-layer thermal laminating film 30. The process for manufacturing the 3-layer thermal laminating film 30 utilizes many of the same manufacturing steps with substantially the same equipment as utilized in the manufacture of the 2-layer thermal laminating film 10, including unwinding the roll 50 of thermoplastic polymer sheet material, optionally corona-treating one or more surfaces of the base layer 34, optionally coating the corona-treated surface of the base layer 34 with a primer 60, drying the primer coating on the base layer 34, cooling the film 30, and winding the film 30 into a roll 88. Therefore, like components are labeled with like reference numerals.

However, to manufacture the 3-layer thermal laminating film 30, a co-extrusion process is utilized to apply the tackified resin layer 42 and the tie layer 38 into coupled relation with the base layer 34. In other words, as shown in FIG. 4, two extruders are utilized—a first extruder 74a for extruding the tackified resin layer 42 and a second extruder 74b for extruding the tie layer 38. The first extruder 74a for extruding the tackified resin layer 42 is configured and operates substantially the same as the single extruder 74 utilized in the single extrusion process illustrated in FIG. 3, except that there is no die dedicated to extruding only the liquefied resin generated by the first extruder 74a. Like components are labeled with like reference numerals designated as “a”, and the components and operation of the first extruder 74a will not be described again in detail.

The second extruder 74b for extruding the tie layer 38 receives pellets of raw component materials of the tie layer 38 from a second storage hopper 70b, and heats the pellets to liquefy the raw material. Each extruder 74a, 74b produces liquefied raw material that is passed through a single die 90. The single die 90 receives the liquefied tie layer and the liquefied tackified resin layer and co-extrudes a combined flow or curtain 94 of the tie layer 38 and the tackified resin layer 42 onto the base layer 34. Even with such a combined flow or curtain of the tie layer 38 and the tackified resin layer 42, two generally distinct layers (i.e., the tie layer 38 and the tackified resin layer 42) will be formed, perhaps with a small blending of layers at the interface between the tie layer 38 and the tackified layer 42.

Alternatively, the 3-layer thermal laminating film 30 may be manufactured using a single extrusion process, like that shown in FIG. 3, twice, first applying the tie layer 38 to the base layer 34, and then applying the tackified resin layer 42 to the tie layer 38 in a second pass through the extrusion device 66.

Further advantages provided by the present invention will become apparent from the following working and prophetic examples.

### EXAMPLE 1

In the following Example, a 2-layer thermal laminating film, in accordance with the present invention, was prepared and tested for physical properties. More particularly, a base thermoplastic polymer sheet layer comprising an oriented polypropylene sheet having a thickness of 12 microns was employed. A tackified resin layer was extruded onto the surface of the base layer (without any corona treatment or primer coating) to a thickness of 13 microns using commercially available RandCastle equipment capable of accommodating a base layer of about 12 inches in width. The composition of the tackified resin layer extruded onto the surface of the base layer was as follows:

| | |
|---|---|
| Polymeric Resin: | 70% by weight low density polyethylene having a |
| | density of 0.88 kg/L and a melt index of |
| | 30 grams/10 min. at 190° C. |
| Tackifier Resin: | 30% by weight hydrogenated aliphatic hydrocarbon |
| | resin having a molecular weight of 2000 grams/mol |

The thermal laminating film thus prepared was thermally laminated using commercially available thermal lamination equipment onto a printed media to form a thermal laminate assembly that provided superior adhesion to the printed media when compared to other commercially available thermal laminating films without the tackified resin layer. The above composition of the tackified resin layer adhered well to the base layer due to the relatively low weight percentage of the LMW hydrocarbon resin and the relatively low melt index (i.e., high melt viscosity) such that no tie layer was necessary.

### EXAMPLE 2

In the following Example, a 2-layer thermal laminating film, in accordance with the present invention, is prepared and tested for physical properties. More particularly, a base thermoplastic polymer sheet layer comprising an oriented polypropylene sheet having a thickness of 12 microns is employed. A tackified resin layer is directly extruded, with or without using either corona-treating or primer coating, onto the base layer to a thickness of 25 microns using commercially available Black Clawson equipment capable of accommodating a base layer of about 90 inches in width. The composition of the tackified resin layer extruded onto the surface of the base layer is as follows:

| | |
|---|---|
| Polymeric Resin: | 50% by weight ethylene vinyl acetate containing 18% |
| | by weight vinyl acetate content and a melt index of |
| | 15 grams/10 min. at 190° C. |
| Tackifier Resin: | 50% by weight hydrogenated cycloaliphatic |
| | hydrocarbon resin having a molecular weight of |
| | 430 grams/mol |

The thermal laminating film thus prepared is thermally laminated using commercially available thermal lamination equipment onto a printed media to form a thermal laminate assembly that is expected to provide superior adhesion to the printed media when compared to other commercially available thermal laminating films without the tackified resin layer. The above composition of the tackified resin layer is expected to adhere well to the base layer due to the relatively low melt index (i.e., high melt viscosity) such that no tie layer is necessary.

### EXAMPLE 3

In the following Example, a 2-layer thermal laminating film, in accordance with the present invention, was prepared and tested for physical properties. More particularly, a base thermoplastic polymer sheet layer comprising an oriented polypropylene sheet having a thickness of 12 microns was employed. A tackified resin layer was manually extruded, without using either corona-treating or primer coating, onto the base layer to a thickness of 25 microns. The manual extrusion process occurred as follows. First the melted tackified resin material was applied onto the base layer in a strip about three inches wide. Next, a drawdown process of the type typically known in the coating industry was used to uniformly coat the base layer to provide about a four inch wide strip of usable film. The drawdown tool defines a vertical gap or space of 25 microns between the surface of the base layer and the bottom of the tool so that as the tool is drawn along the base layer, the 25 micron tackified resin layer is extruded through the gap defined between the drawdown tool and the base layer (the drawdown tool acts as the die) to evenly coat the base layer. After the drawdown, the film was left to air cool at room temperature. The composition of the tackified resin layer extruded onto the surface of the base layer was as follows:

| | |
|---|---|
| Polymeric Resin: | 50% by weight ethylene vinyl acetate containing 18% |
| | by weight vinyl acetate content and a melt index of |
| | 15 grams/10 min. at 190° C. |
| Tackifier Resin: | 50% by weight hydrogenated cycloaliphatic |
| | hydrocarbon resin having a molecular weight of |
| | 430 grams/mol |

The thermal laminating film thus prepared was thermally laminated using commercially available thermal lamination equipment onto a printed media to form a thermal laminate assembly that provided superior adhesion to the printed media when compared to other commercially available thermal laminating films without the tackified resin layer. The above composition of the tackified resin layer adhered well to the base layer due to the relatively low melt index (i.e., high melt viscosity) such that no tie layer was necessary.

### EXAMPLE 4

In the following Example, a 2-layer thermal laminating film, in accordance with the present invention, was prepared and tested for physical properties. More particularly, a base thermoplastic polymer sheet layer comprising an oriented polyester sheet having a thickness of 12 microns was employed. A tackified resin layer was extruded onto the surface of the base layer (without any corona treatment or primer coating) to a thickness of 13 microns using commercially available RandCastle equipment capable of accommodating a base layer of about 12 inches in width. The composition of the tackified resin layer extruded onto the surface of the base layer was as follows:

| | |
|---|---|
| Polymeric Resin: | 70% by weight low density polyethylene having a |
| | density of 0.88 kg/L and a melt index of |
| | 30 grams/10 min. at 190° C. |
| Tackifier Resin: | 30% by weight hydrogenated aliphatic hydrocarbon |
| | resin having a molecular weight of 2000 grams/mol |

The thermal laminating film thus prepared formed a thermal laminate assembly that provided superior adhesion to the printed media when compared to other commercially available thermal laminating films without the tackified resin layer. The above composition of the tackified resin layer adhered well to the base layer due to the relatively low weight percentage of the LMW hydrocarbon resin and the relatively low melt index (i.e., high melt viscosity) such that no tie layer was necessary.

### EXAMPLE 5

In the following Example, a 2-layer thermal laminating film, in accordance with the present invention, was prepared and tested for physical properties. More particularly, a base thermoplastic polymer sheet layer comprising an oriented polyester sheet having a thickness of 23 microns was employed. A tackified resin layer was manually extruded, without using either corona-treating or primer coating, onto the base layer to a thickness of 25 microns. The manual extrusion process occurred as follows. First the melted tackified resin material was applied onto the base layer in a strip about three inches wide. Next, a drawdown process of the type typically known in the coating industry was used to uniformly coat the base layer to provide about a four inch wide strip of usable film. The drawdown tool defines a vertical gap or space of 25 microns between the surface of the base layer and the bottom of the tool so that as the tool is drawn along the base layer, the 25 micron tackified resin layer is extruded through the gap defined between the drawdown tool and the base layer (the drawdown tool acts as the die) to evenly coat the base layer. After the drawdown, the film was left to air cool at room temperature. The composition of the tackified resin layer extruded onto the surface of the base layer was as follows:

| | |
|---|---|
| Polymeric Resin: | 80% by weight ethylene vinyl acetate containing 16% |
| | by weight vinyl acetate content and a melt index of |
| | 28 grams/10 min. at 190° C. |
| Tackifier Resin: | 20% by weight hydrogenated rosin having a |
| | molecular weight of 750 grams/mol |

The thermal laminating film thus prepared was thermally laminated using commercially available thermal lamination equipment onto a printed media to form a thermal laminate assembly that provided superior adhesion to the printed media when compared to other commercially available thermal laminating films without the tackified resin layer. The above composition of the tackified resin layer adhered well to the base layer due to the relatively low melt index (i.e., high melt viscosity) such that no tie layer was necessary.

### EXAMPLE 6

In the following Example, a 3-layer thermal laminating film, in accordance with the present invention, is prepared and tested for physical properties. More particularly, a base thermoplastic polymer sheet layer comprising an oriented polypropylene sheet having a thickness of 12 microns is employed. A tie layer having a thickness of 10 microns and a tackified resin layer having a thickness of 3 microns is co-extruded, with or without using either corona-treating or primer coating, onto the base layer using commercially available Black Clawson equipment capable of accommodating a base layer of about 90 inches in width. The tie layer co-extruded onto the surface of the base layer is ethylene vinyl acetate copolymer containing 18% by weight vinyl acetate content and a melt index of 20 grams/10 min. at 190° C. The composition of the tackified resin layer extruded onto the surface of the base layer is as follows:

| | |
|---|---|
| Polymeric Resin: | 50% by weight ethylene vinyl acetate copolymer |
| | containing 18% by weight vinyl acetate content and a |
| | melt index of 15 grams/10 min. at 190° C. |
| Tackifier Resin: | 50% by weight hydrogenated cycloaliphatic |
| | hydrocarbon resin having a molecular weight of |
| | 430 grams/mol |

The thermal laminating film thus prepared is thermally laminated using commercially available thermal lamination equipment onto a printed media to form a thermal laminate assembly that is expected to provide superior adhesion to the printed media when compared to other commercially available thermal laminating films without the tackified resin layer. While the above composition of the tackified resin layer is also used in Example 2 above to create a 2-layer thermal laminating film without a tie layer, Example 2 is expected to be possible largely due to the relatively low melt index of the tackified resin layer. However, the relatively large percentage of the tackifier or LMW hydrocarbon resin in the tackified resin layer can also be a consideration for forming a 3-layer film, in which the tie layer is used to promote adhesion of the tackified resin layer to the base layer. Furthermore, the 3-layer film of this Example uses less of the more expensive tackifier resin than the 2-layer film of Example 2 (based on the difference in the thicknesses of the tackified resin layers), which also promotes the use of the construction of Example 6.

### EXAMPLE 7

In the following Example, a 3-layer thermal laminating film, in accordance with the present invention, was prepared and tested for physical properties. More particularly, a base thermoplastic polymer sheet layer comprising an oriented polypropylene sheet having a thickness of 12 microns was employed. A previously-extruded tie layer having a thickness of 10 microns was present on the base layer. A tackified resin layer having a thickness of 3 microns was extruded onto the tie layer using commercially available RandCastle equipment capable of accommodating a base layer of about 12 inches in width. The tie layer previously extruded onto the surface of the base layer was ethylene vinyl acetate copolymer containing 18% by weight vinyl acetate content and a melt index of 20 grams/10 min. at 190° C. The composition of the tackified resin layer extruded onto the tie layer was as follows:

| | |
|---|---|
| Polymeric Resin: | 50% by weight ethylene vinyl acetate copolymer |
| | containing 18% by weight vinyl acetate content and a |
| | melt index of 15 grams/10 min. at 190° C. |
| Tackifier Resin: | 50% by weight hydrogenated cycloaliphatic |
| | hydrocarbon resin having a molecular weight of |
| | 430 grams/mol |

The thermal laminating film thus prepared was thermally laminated using commercially available thermal lamination equipment onto a printed media to form a thermal laminate assembly that provided superior adhesion to the printed media when compared to other commercially available thermal laminating films without the tackified resin layer. While the above composition of the tackified resin layer is also used in Example 2 above to create a 2-layer thermal laminating film without a tie layer, Example 2 is expected to be possible largely due to the relatively low melt index of the tackified resin layer. However, the relatively large percentage of the tackifier or LMW hydrocarbon resin in the tackified resin layer can also be a consideration for forming a 3-layer film, in which the tie layer is used to promote adhesion of the tackified resin layer to the base layer. Furthermore, the 3-layer film of this Example uses less of the more expensive tackifier resin than the 2-layer film of Example 2 (based on the difference in the thicknesses of the tackified resin layers), which also promotes the use of the construction of Example 7.

### EXAMPLE 8

In the following Example, a 3-layer thermal laminating film, in accordance with the present invention, was prepared and tested for physical properties. More particularly, a base thermoplastic polymer sheet layer comprising an oriented polyester sheet having a thickness of 12 microns was employed. A previously-extruded tie layer having a thickness of 10 microns was present on the base layer. A tackified resin layer having a thickness of 5 microns was extruded onto the tie layer using commercially available RandCastle equipment capable of accommodating a base layer of about 12 inches in width. The tie layer previously extruded onto the surface of the base layer was ethylene vinyl acetate copolymer containing 16% by weight vinyl acetate content and a melt index of 28 grams/10 min. at 190° C. The composition of the tackified resin layer extruded onto the tie layer was as follows:

| | |
|---|---|
| Polymeric Resin: | 50% by weight ethylene vinyl acetate copolymer |
| | containing 18% by weight vinyl acetate content and a |
| | melt index of 150 grams/10 min. at 190° C. |
| Tackifier Resin: | 50% by weight hydrogenated cycloaliphatic |
| | hydrocarbon resin having a molecular weight of |
| | 430 grams/mol |

The thermal laminating film thus prepared was thermally laminated using commercially available thermal lamination equipment onto a printed media to form a thermal laminate assembly that provided superior adhesion to the printed media when compared to other commercially available thermal laminating films without the tackified resin layer. In this example, the combination of the relatively high melt index (i.e., relatively low melt viscosity) and the relatively high LMW hydrocarbon resin content of the tackified resin layer promotes the use of the tie layer to obtain good adhesion of the tackified resin layer to the base layer.

### EXAMPLE 9

In the following Example, a 3-layer thermal laminating film, in accordance with the present invention, was prepared and tested for physical properties. More particularly, a base thermoplastic polymer sheet layer comprising an oriented polyester sheet having a thickness of 12 microns was employed. A previously-extruded tie layer having a thickness of 10 microns was present on the base layer. A tackified resin layer having a thickness of 5 microns was extruded onto the tie layer using commercially available RandCastle equipment capable of accommodating a base layer of about 12 inches in width. The tie layer previously extruded onto the surface of the base layer was ethylene vinyl acetate copolymer containing 16% by weight vinyl acetate content and a melt index of 28 grams/10 min. at 190° C. The composition of the tackified resin layer extruded onto the tie layer was as follows:

| | |
|---|---|
| Polymeric Resin A: | 45% by weight ethylene vinyl acetate copolymer |
| | containing 18% by weight vinyl acetate content and |
| | a melt index of 500 grams/10 min. at 190° C. |
| Polymeric Resin B: | 10% by weight ethylene vinyl acetate copolymer |
| | containing 10% by weight vinyl acetate content and |
| | a melt index of 12 grams/10 min. at 190° C. |
| Tackifier Resin A: | 30% by weight partially-hydrogenated aromatic |
| | hydrocarbon resin having a molecular weight of |
| | 2500 grams/mol |
| Tackifier Resin B: | 15% by weight hydrogenated rosin having a |
| | molecular weight of 750 grams/mol |

The thermal laminating film thus prepared was thermally laminated using commercially available thermal lamination equipment onto a printed media to form a thermal laminate assembly that provided superior adhesion to the printed media when compared to other commercially available thermal laminating films without the tackified resin layer. In this example, the combination of the relatively high melt index (i.e., relatively low melt viscosity) and the relatively high LMW hydrocarbon resin content of the tackified resin layer promotes the use of the tie layer to obtain good adhesion of the tackified resin layer to the base layer.

### EXAMPLE 10

In the following Example, a 3-layer thermal laminating film, in accordance with the present invention, was prepared and tested for physical properties. More particularly, a base thermoplastic polymer sheet layer comprising an oriented polyester sheet having a thickness of 23 microns was employed. A previously-extruded tie layer having a thickness of 25 microns was present on the base layer. A tackified resin layer was manually extruded onto the tie layer to a thickness of 25 microns. The manual extrusion process occurred as follows. First the melted tackified resin material was applied onto the base layer in a strip about three inches wide. Next, a drawdown process of the type typically known in the coating industry was used to uniformly coat the base layer to provide about a four inch wide strip of usable film. The drawdown tool defines a vertical gap or space of 25 microns between the surface of the base layer and the bottom of the tool so that as the tool is drawn along the base layer, the 25 micron tackified resin layer is extruded through the gap defined between the drawdown tool and the base layer (the drawdown tool acts as the die) to evenly coat the base layer. After the drawdown, the film was left to air cool at room temperature. The tie layer previously extruded onto the surface of the base layer was ethylene vinyl acetate copolymer containing 16% by weight vinyl acetate content and a melt index of 28 grams/10 min. at 190° C. The composition of the tackified resin layer extruded onto the tie layer was as follows:

| | |
|---|---|
| Polymeric Resin: | 50% by weight ethylene vinyl acetate copolymer |
| | containing 16% by weight vinyl acetate content and a |
| | melt index of 28 grams/10 min. at 190° C. |
| Tackifier Resin: | 50% by weight rosin ester having a |
| | molecular weight of 800 grams/mol |

The thermal laminating film thus prepared was thermally laminated using commercially available thermal lamination equipment onto a printed media to form a thermal laminate assembly that provided superior adhesion to the printed media when compared to other commercially available thermal laminating films without the tackified resin layer. In this example, the relatively high LMW hydrocarbon resin content of the tackified resin layer promotes the use of the tie layer to obtain good adhesion of the tackified resin layer to the base layer.

### EXAMPLE 11

In the following Example, a 3-layer thermal laminating film, in accordance with the present invention, was prepared and tested for physical properties. More particularly, a base thermoplastic polymer sheet layer comprising an oriented polyester sheet having a thickness of 23 microns was employed. A previously-extruded tie layer having a thickness of 25 microns was present on the base layer. A tackified resin layer was manually extruded onto the tie layer to a thickness of 25 microns. The manual extrusion process occurred as follows. First the melted tackified resin material was applied onto the base layer in a strip about three inches wide. Next, a drawdown process of the type typically known in the coating industry was used to uniformly coat the base layer to provide about a four inch wide strip of usable film. The drawdown tool defines a vertical gap or space of 25 microns between the surface of the base layer and the bottom of the tool so that as the tool is drawn along the base layer, the 25 micron tackified resin layer is extruded through the gap defined between the drawdown tool and the base layer (the drawdown tool acts as the die) to evenly coat the base layer. After the drawdown, the film was left to air cool at room temperature. The tie layer previously extruded onto the surface of the base layer was ethylene vinyl acetate copolymer containing 16% by weight vinyl acetate content and a melt index of 28 grams/10 min. at 190° C. The composition of the tackified resin layer extruded onto the tie layer was as follows:

| | |
|---|---|
| Polymeric | 35% by weight ethylene vinyl acetate copolymer containing |
| Resin A: | 16% by weight vinyl acetate content and a melt |
| | index of 15 grams/10 min. at 190° C. |
| Tackifier | 50% by weight partially-hydrogenated aromatic hydrocarbon |
| Resin A: | resin having a molecular weight of 2500 grams/mol |
| Tackifier | 15% by weight hydrogenated rosin having a molecular |
| Resin B: | weight of 750 grams/mol |

The thermal laminating film thus prepared was thermally laminated using commercially available thermal lamination equipment onto a printed media to form a thermal laminate assembly that provided superior adhesion to the printed media when compared to other commercially available thermal laminating films without the tackified resin layer. In this example, the relatively high LMW hydrocarbon resin content of the tackified resin layer the use of the tie layer to obtain good adhesion of the tackified resin layer to the base layer.

Various features of the invention are set forth in the following claims.

What is claimed is:

1. A thermal laminating film comprising:
a tackified resin.

2. The thermal laminating film of claim 1, wherein the thermal laminating film further includes a base layer, and wherein the tackified resin forms a tackified resin layer coupled to the base layer.

3. The thermal laminating film of claim 2, wherein the tackified resin layer is extruded onto the base layer.

4. The thermal laminating film of claim 2, wherein the tackified resin layer has a thickness of at least about 4 microns.

5. The thermal laminating film of claim 2, further comprising a polymeric resin layer coupled between the base layer and the tackified resin layer.

6. The thermal laminating film of claim 5, wherein the polymeric resin layer and the tackified resin layer include a combined thickness of at least about 4 microns.

7. The thermal laminating film of claim 5, wherein the polymeric resin layer has a thickness of at least about 2 microns, and wherein the tackified resin layer includes a thickness of at least about 2 microns.

8. The thermal laminating film of claim 5, wherein the polymeric resin layer and the tackified resin layer are co-extruded onto the base layer.

9. The thermal laminating film of claim 1, wherein the tackified resin includes a polymeric resin and a low-molecular-weight hydrocarbon resin, and wherein the tackified resin includes at least about 20% by weight of the low-molecular-weight hydrocarbon resin.

10. The thermal laminating film of claim 1, wherein the tackified resin includes a polymeric resin and a low-molecular-weight hydrocarbon resin, and wherein the tackified resin includes less than or equal to about 70% by weight of the low-molecular-weight hydrocarbon resin.

11. The thermal laminating film of claim 1, wherein the tackified resin includes a polymeric resin and a low-molecular-weight hydrocarbon resin, and wherein the tackified resin includes about 30% to about 50% by weight of the low-molecular-weight hydrocarbon resin.

12. The thermal laminating film of claim 1, wherein the tackified resin includes a polymeric resin and a low-molecular-weight hydrocarbon resin, and wherein the tackified resin includes about 20% to about 45% by weight of the low-molecular-weight hydrocarbon resin.

13. The thermal laminating film of claim 1, wherein the tackified resin includes a polymeric resin and a low-molecular-weight hydrocarbon resin, and wherein the tackified resin includes about 40% to about 65% by weight of the hydrocarbon resin.

14. The thermal laminating film of claim 1, wherein the tackified resin includes a polymeric resin and a low-molecular-weight hydrocarbon resin, and wherein the polymeric resin includes at least one of an ethylene vinyl acetate copolymer, a low-density polyethylene polymer, an ethylene methyl acrylate copolymer, an ethylene methyl methacrylate copolymer, and an ethylene ethyl acrylate copolymer.

15. The thermal laminating film of claim 1, wherein the tackified resin includes a polymeric resin and a low-molecular-weight hydrocarbon resin, and wherein the low-molecular-weight hydrocarbon resin includes at least one of an aliphatic hydrocarbon resin, an aromatic hydrocarbon resin, a cycloaliphatic hydrocarbon resin, a rosin, and a rosin ester.

16. The thermal laminating film of claim 1, wherein the tackified resin includes about 50% by weight ethylene vinyl acetate copolymer, and wherein the tackified resin includes about 50% by weight cycloaliphatic hydrocarbon resin.

17. The thermal laminating film of claim 1, wherein the tackified resin includes about 55% by weight ethylene vinyl acetate copolymer, and wherein the tackified resin includes about 30% by weight aromatic hydrocarbon resin and about 15% by weight rosin.

18. The thermal laminating film of claim 1, wherein the tackified resin includes about 50% by weight ethylene vinyl acetate copolymer, and wherein the tackified resin includes about 50% by weight rosin ester.

19. The thermal laminating film of claim 1, wherein the tackified resin includes about 70% by weight low-density polyethylene polymer, and wherein the tackified resin includes about 30% by weight hydrogenated aliphatic hydrocarbon resin.

20. A thermal laminating film comprising:
a base layer;
a polymeric resin layer coupled to the base layer; and
a tackified resin layer coupled to the polymeric resin layer.

21. The thermal laminating film of claim 20, wherein the polymeric resin layer and the tackified resin layer are co-extruded onto the base layer.

22. The thermal laminating film of claim 20, wherein the polymeric resin layer and the tackified resin layer have a combined thickness of at least about 4 microns.

23. The thermal laminating film of claim 20, wherein the polymeric resin layer has a thickness of at least about 2 microns, and wherein the tackified resin layer has a thickness of at least about 2 microns.

24. The thermal laminating film of claim 20, wherein the tackified resin layer includes a polymeric resin and a low-molecular-weight hydrocarbon resin, and wherein the tackified resin layer includes at least about 20% by weight of the low-molecular-weight hydrocarbon resin.

25. The thermal laminating film of claim 20, wherein the tackified resin layer includes a polymeric resin and a low-molecular-weight hydrocarbon resin, and wherein the tackified resin layer includes less than or equal to about 70% by weight of the low-molecular-weight hydrocarbon resin.

26. The thermal laminating film of claim 20, wherein the tackified resin layer includes a polymeric resin and a low-molecular-weight hydrocarbon resin, and wherein the tackified resin layer includes about 30% to about 50% by weight of the low-molecular-weight hydrocarbon resin.

27. The thermal laminating film of claim 20, wherein the tackified resin layer includes a polymeric resin and a low-molecular-weight hydrocarbon resin, and wherein the tackified resin layer includes about 20% to about 45% by weight of the low-molecular-weight hydrocarbon resin.

28. The thermal laminating film of claim 20, wherein the tackified resin layer includes a polymeric resin and a low-molecular-weight hydrocarbon resin, and wherein the tackified resin layer includes about 40% to about 65% by weight of the low-molecular-weight hydrocarbon resin.

29. The thermal laminating film of claim 20, wherein the polymeric resin layer includes at least one of an ethylene vinyl acetate copolymer, a low-density polyethylene polymer, an ethylene methyl acrylate copolymer, an ethylene methyl methacrylate copolymer, and an ethylene ethyl acrylate copolymer.

30. The thermal laminating film of claim 20, wherein the tackified resin layer includes a polymeric resin and a low-molecular-weight hydrocarbon resin, and wherein the polymeric resin includes at least one of an ethylene vinyl acetate copolymer, a low-density polyethylene polymer, an ethylene methyl acrylate copolymer, an ethylene methyl methacrylate copolymer, and an ethylene ethyl acrylate copolymer.

31. The thermal laminating film of claim 20, wherein the tackified resin layer includes a polymeric resin and a low-molecular-weight hydrocarbon resin, and wherein the low-molecular-weight hydrocarbon resin includes at least one of an aliphatic hydrocarbon resin, an aromatic hydrocarbon resin, a cycloaliphatic hydrocarbon resin, a rosin, and a rosin ester.

32. The thermal laminating film of claim 20, wherein the tackified resin layer includes about 50% by weight ethylene vinyl acetate copolymer, and wherein the tackified resin layer includes about 50% by weight cycloaliphatic hydrocarbon resin.

33. The thermal laminating film of claim 20, wherein the tackified resin layer includes about 55% by weight ethylene vinyl acetate copolymer, and wherein the tackified resin layer includes about 30% by weight aromatic hydrocarbon resin and about 15% by weight rosin.

34. The thermal laminating film of claim 20, wherein the tackified resin layer includes about 50% by weight ethylene vinyl acetate copolymer, and wherein the tackified resin layer includes about 50% by weight rosin ester.

35. The thermal laminating film of claim 20, wherein the tackified resin layer includes about 70% by weight low-density polyethylene polymer, and wherein the tackified resin layer includes about 30% by weight hydrogenated aliphatic hydrocarbon resin.

36. A method of manufacturing a thermal laminating film, the method comprising:
providing a base layer; and
extruding a tackified resin layer into coupled relation with the base layer.

37. The method of claim 36, wherein extruding the tackified resin layer includes extruding the tackified resin layer to a thickness of at least about 4 microns.

38. The method of claim 36, wherein extruding the tackified resin layer includes extruding a polymeric resin and a low-molecular-weight hydrocarbon resin, and wherein the tackified resin layer includes at least about 20% by weight of the low-molecular-weight hydrocarbon resin.

39. The method of claim 36, wherein extruding the tackified resin layer includes extruding a polymeric resin and a low-molecular-weight hydrocarbon resin, and wherein the tackified resin layer includes less than or equal to about 70% by weight of the low-molecular-weight hydrocarbon resin.

40. The method of claim 36, wherein extruding the tackified resin layer includes extruding a polymeric resin and a low-molecular-weight hydrocarbon resin, and wherein the tackified resin layer includes about 30% to about 50% by weight of the low-molecular-weight hydrocarbon resin.

41. The method of claim 36, wherein extruding the tackified resin layer includes extruding a polymeric resin and a low-molecular-weight hydrocarbon resin, and wherein the tackified resin layer includes about 20% to about 45% by weight of the low-molecular-weight hydrocarbon resin.

42. The method of claim 36, wherein extruding the tackified resin layer includes extruding a polymeric resin and a low-molecular-weight hydrocarbon resin, and wherein the tackified resin layer includes about 40% to about 65% by weight of the low-molecular-weight hydrocarbon resin.

43. The method of claim 36, wherein extruding the tackified resin layer includes extruding a polymeric resin and a low-molecular-weight hydrocarbon resin, and wherein the polymeric resin includes at least one of an ethylene vinyl acetate copolymer, a low-density polyethylene polymer, an ethylene methyl acrylate copolymer, an ethylene methyl methacrylate copolymer, and an ethylene ethyl acrylate copolymer.

44. The method of claim 36, wherein extruding the tackified resin layer includes extruding a polymeric resin and a low-molecular-weight hydrocarbon resin, and wherein the low-molecular-weight hydrocarbon resin includes at least one of an aliphatic hydrocarbon resin, an aromatic hydrocarbon resin, a cycloaliphatic hydrocarbon resin, a rosin, and a rosin ester.

45. The method of claim 36, wherein extruding the tackified resin layer includes extruding a composition of about 50% by weight ethylene vinyl acetate copolymer, and about 50% by weight cycloaliphatic hydrocarbon resin.

46. The method of claim 36, wherein extruding the tackified resin layer includes extruding a composition of about 55% by weight ethylene vinyl acetate copolymer, about 30% by weight aromatic hydrocarbon resin and about 15% by weight rosin.

47. The method of claim 36, wherein extruding the tackified resin layer includes extruding a composition of about 50% by weight ethylene vinyl acetate copolymer, and about 50% by weight rosin ester.

48. The method of claim 36, wherein extruding the tackified resin layer includes extruding a composition of about 70% by weight low-density polyethylene polymer, and about 30% by weight hydrogenated aliphatic hydrocarbon resin.

49. The method of claim 36, further comprising extruding a polymeric resin layer between the base layer and the tackified resin layer.

50. The method of claim 49, wherein extruding the polymeric resin layer and extruding the tackified resin layer includes co-extruding the polymeric resin layer and the tackified resin layer through a single die.

51. The method of claim 49, wherein extruding the polymeric resin layer includes extruding at least one of an ethylene vinyl acetate copolymer, a low-density polyethylene polymer, an ethylene methyl acrylate copolymer, an ethylene methyl methacrylate copolymer, and an ethylene ethyl acrylate copolymer.

52. The method of claim 49, wherein extruding the polymeric resin layer and the tackified resin layer includes extruding the polymeric resin layer and the tackified resin layer to a combined thickness of at least about 4 microns.

53. The method of claim 49, wherein extruding the polymeric resin layer includes extruding the polymeric resin layer to a thickness of at least about 2 microns, and wherein extruding the tackified resin layer includes extruding the tackified resin layer to a thickness of at least about 2 microns.
